(19) United States
(12) Patent Application Publication
(10) Pub. No.: US 2013/0160314 A1
(43) Pub. Date: Jun. 27, 2013

(54) T-plotter: tool for plotting celestial lines of position

(71) Applicant: Peter Hakel, (US)

(72) Inventor: Peter Hakel, (US)

(21) Appl. No.: 13/337,483

(22) Filed: Dec. 27, 2011

(51) Int. Cl. B43L 7/02

(52) U.S. Cl. 33/479

(57) ABSTRACT

The T-plotter is a T-shaped transparent plotting utensil consisting of two mutually perpendicular arms and equipped with a rotatable compass rose mounted on a shuttle sliding along its arm of symmetry. This device allows a simplified plotting of celestial lines of position according to the intercept method of Marcq St. Hilaire. The compass rose is used to dial in the required azimuth. The intercept distance is marked by sliding the shuttle to the appropriate distance from the top of the main body based on the latitude scale of the employed nautical chart.

### CROSS-REFERENCE TO RELATED APPLICATIONS

N/A

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM, LISTING COMPACT DISC APPENDIX

N/A

### BACKGROUND OF THE INVENTION

Celestial navigation is a collection of traditional mathematics and geometry methods for establishing and tracking the positions of vessels at sea based on astronomical observations. Even today in the age of the Global Positioning System (GPS) celestial navigation continues to be of interest to mariners and enthusiasts. For over a century the intercept method of Marcq St. Hilaire has been the workhorse technique of translating a chronometer-timed sextant altitude observation of a celestial object into a line of position (LOP) plotted on a nautical chart. The crossing of at least two separate LOPs then marks the vessel's location with accuracy that is adequate for sailing out of sight of land. The subject of this application is the T-plotter (FIG. 1), a device that enables a simplified plotting of the celestial LOP on a plotting sheet or on a nautical chart constructed in the Mercator projection.

According to the intercept method of Marcq St. Hilaire a celestial LOP is characterized by the latitude (Lat) and the longitude (Lon) of the so-called assumed position (AP), the azimuth Z toward the geographical position (GP) of the observed celestial body, and the intercept distance (or intercept) a measured in nautical miles (NM), which can be directed either toward (T) or away (A) from the GP along the Z-azimuth line originating from the AP. The above mentioned quantities are the results of sight-reduction procedures that the navigator performs prior to the plotting of the LOP. Once these characteristics have been established, the LOP (along which the vessel is located) can be plotted on a chart as the line running perpendicular to the azimuth line and crossing it at the intercept point.

I am aware of the following two U.S. patents granted for inventions that provided solutions to tasks similar to the subject of this my application; these are US 2,916,207—M. G. Vohland, Dec. 8, 1959, and U.S. Pat. No. 4,170,065—D. W. Hiscott, Oct. 9, 1979. As I specify in my claims below, my invention is distinctly different from prior art due to: 1) the T-shape of the main body of the invention, and, 2) the mounting of the compass rose on a shuttle sliding relative to the device's main body.

### BRIEF SUMMARY OF THE INVENTION

The most common LOP plotting procedure involves the use of parallel rules for the transferring of azimuth bearings from the chart's compass rose onto the AP, dividers to mark the intercept distance based on the chart's latitude scale onto the azimuth line, and triangles for drawing both the azimuth line and the LOP. The T-plotter allows the same LOP to be drawn with a single plotting aid on charts of any scale, without the use of the intermediate azimuth line, and without the need to transfer bearings by sliding any device on the potentially uneven surface of the chart.

### BRIEF DESCRIPTION OF THE SEVERAL VIEWS OF THE DRAWING

FIG. 1. Top view of the fully assembled T-plotter

FIG. 2. First member—main body only—top view

FIG. 3. Second member—shuttle and compass rose only—top view

FIG. 4. Shuttle mounted on the main body—perspective view along the azimuth arm

FIG. 5. Compass-rose carrying shuttle mounted on the main body—side view

### DETAILED DESCRIPTION OF THE INVENTION

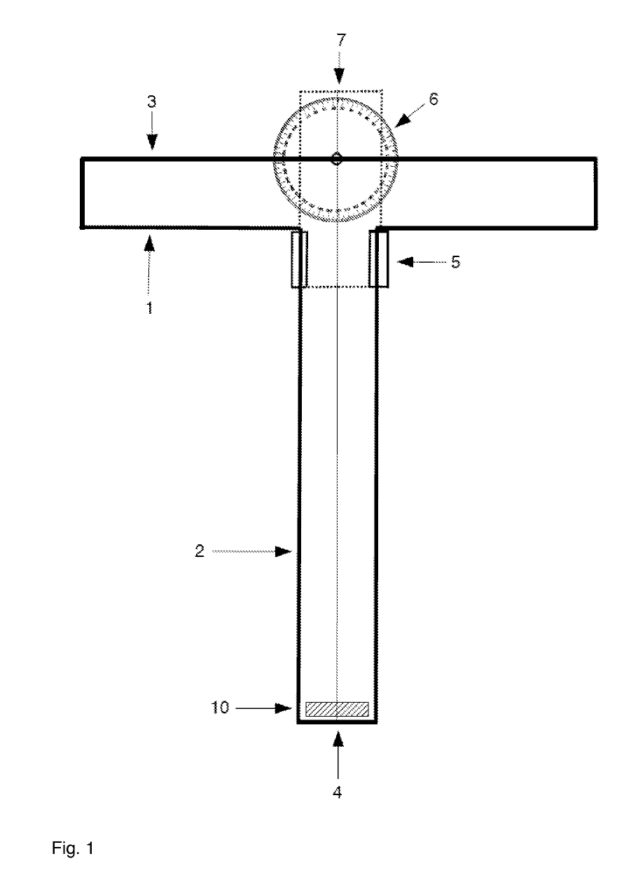

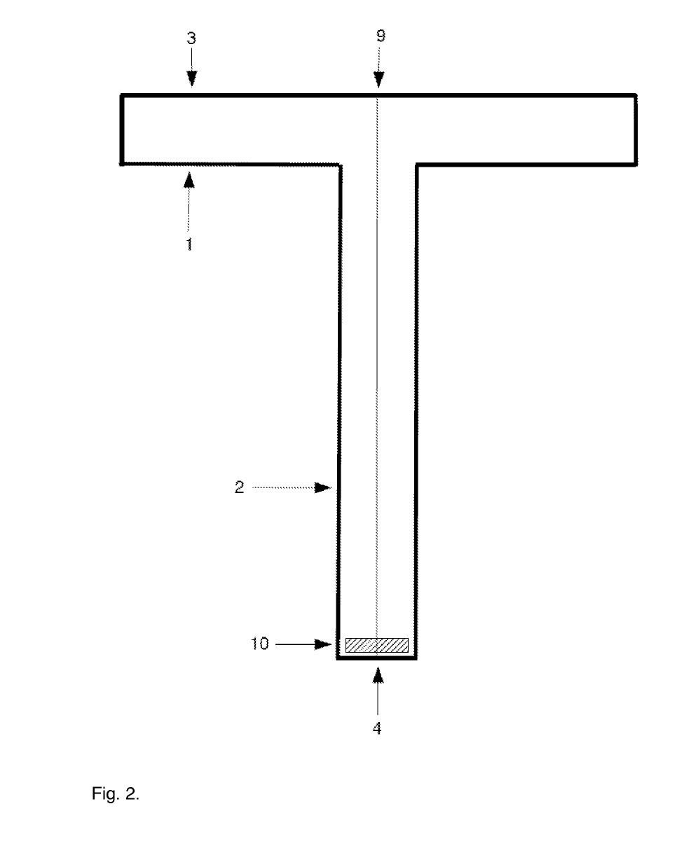

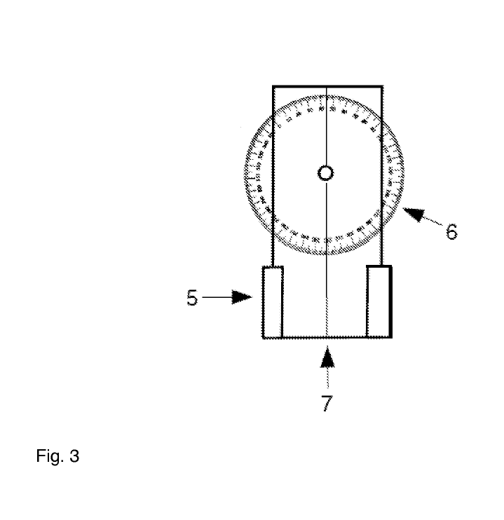

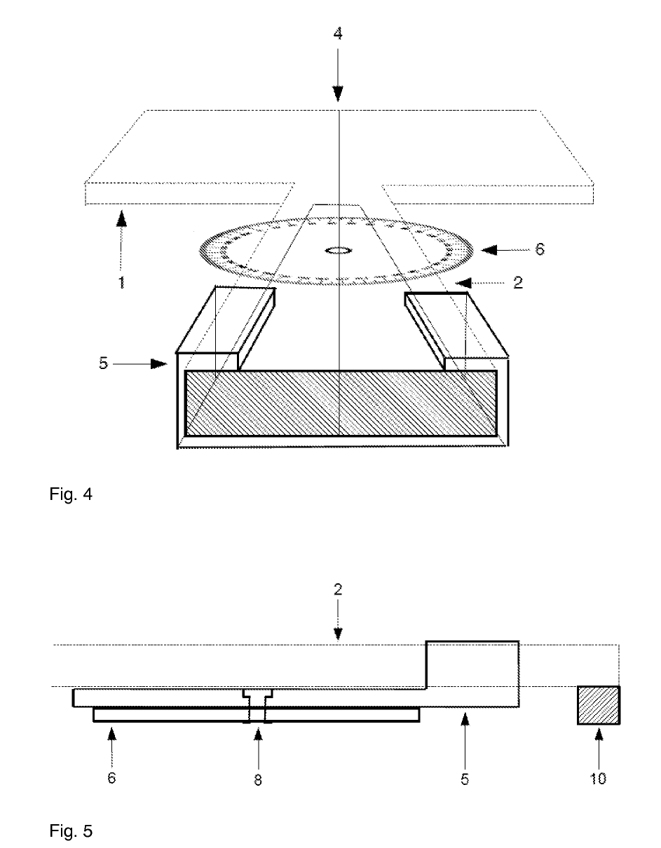

The T-plotter is made of a thin transparent material. The main body (the first member) of the T-plotter is T-shaped and consists of the plotting arm 1 and the arm of symmetry, also called the azimuth arm 2 (FIGS. 1 and 2). The two arms 1 and 2 are perpendicular to each other. The uninterrupted outside edge of the plotting arm is the plotting edge 3. A straight azimuth line 4 is marked along the symmetry axis of the azimuth arm on the bottom side of the main body. The second member of the device is the shuttle 5 that slides along the azimuth arm 2 of the main body and carries with it a rotatable compass rose 6 marked with the usual 360 degree-ticks in the clockwise sense (FIGS. 1, 3, 4, and 5). The diameter of the compass rose 6 is larger than the width of the azimuth arm 2 and the shuttle 5, so that the user can easily grab and rotate the rose with respect to the shuttle. The shuttle 5 extends at least across the full diameter of the compass rose 6 along the azimuth arm 2 of the main body. Another azimuth line 7 is marked on the bottom surface of the shuttle 5 itself. The dimensions of the T-plotter members are such that both the rotation of the compass rose 6 relative to the shuttle 5 and the sliding of the shuttle 5 along the azimuth arm 2 are self-locked via friction. The compass rose 6 is attached to the shuttle 5 with a countersunk eyelet or a grommet 8 that allows the user to see through its center hole (FIG. 5). When the shuttle 5 is in its uppermost position pressed against the plotting arm 1 (FIG. 1), the center of the compass rose is exactly at, or slightly beyond the middle of the plotting edge 3 at the terminus of the azimuth line TAL 9 (FIG. 2); this position represents the intercept distance of zero while accommodating the non-zero thickness of the user's drawing utensil (e.g. pencil). The shuttle is prevented from sliding off the azimuth arm by a transparent bumper 10 attached to the main body (FIGS. 1, 2, and 5). The thicknesses of the shuttle's 5 undercarriage, compass rose 6, bumper 10, and the height of the eyelet or grommet 8 are such that the first member of the T-plotter is kept parallel to the underlying nautical chart during its positioning on the chart (FIG. 5).

### OPERATION OF THE INVENTION

It is hereby understood that the values of Lat, Lon, Z, a, and T/A are all known prior to the use of the T-plotter. The azimuth Z is dialed in by aligning the compass rose 6 with the azimuth lines 4 and 7; azimuths for TOWARD (T) intercepts are marked using the top side of the compass rose (i.e. the side that is closer to the plotting edge 3), and AWAY (A) intercepts are marked away from it. The T-plotter is then placed on the side of the nautical chart with its azimuth lines aligned with the latitude scale. The shuttle 5 is moved into the position in which the distance between the center of the compass rose 8 and the TAL 9 represents the intercept distance a in a manner that is consistent with the scale of the chart. (One arc-minute of latitude along any Earth's meridian equals one nautical mile.) With the shuttle 5 now in the required position and with the compass rose 6 in the correct orientation the T-plotter is placed on the chart with the compass rose aligned with the chart's cardinal directions and its center 8 over the AP. For short intercepts a the shuttle 5 will protrude over the plotting edge 3 which would obstruct the plotting of the LOP. Therefore the shuttle 5 is now moved sufficiently far away from the plotting edge 3 toward the bumper 10 while keeping the T-plotter's position and orientation on the chart. Lightly pressing on the plotting arm 1 will slightly bend the main body thus bringing the plotting edge 3 in contact with the chart. The LOP is now drawn on the chart along the plotting edge 3 of the T-plotter. If the available length of the azimuth arm 2 is insufficient to accommodate the prescribed intercept distance a, then a can be mathematically partitioned into several pieces, each short enough to fit along the azimuth arm 2 given the scale of the chart. In this case the LOP can be arrived at in stages, in which each previous location of TAL 9 becomes the new auxiliary “AP” for the next stage and its part of the intercept distance a. During all these steps the compass rose 6 is kept in its original orientation relative to the shuttle 5 based on azimuth Z and T/A.

I claim:

1) A transparent plotting utensil in the shape of the uppercase letter T, consisting of two mutually perpendicular arms, and whose arm of symmetry is marked with a central line.

2) A transparent shuttle marked with a central line, including a rotatable compass rose, and sliding on the arm of symmetry of the device defined in claim 1).
